(19) United States
(12) Patent Application Publication
(10) Pub. No.: US 2015/0292934 A1
(43) Pub. Date: Oct. 15, 2015

(54) METHOD AND DEVICE FOR ASCERTAINING THE TOTAL MASS OF AN ELECTRICALLY DRIVABLE VEHICLE

(71) Applicant: ROBERT BOSCH GMBH, Stuttgart (DE)

(72) Inventors: Daniel Baumgaertner, Tuebingen (DE); Wolfram Schock, Ohmenhausen (DE); Peter Kimmich, Steinenbronn (DE); Gregor Dasbach, Reutlingen (DE)

(21) Appl. No.: 14/649,877

(22) PCT Filed: Oct. 21, 2013
(86) PCT No.: PCT/EP2013/071919

§ 371 Date: Jun. 4, 2015

(30) Foreign Application Priority Data
Dec. 12, 2012 (DE) 10 2012 222 854.3

(51) Int. Cl. G01G 19/02; G01B 21/22; G01L 5/00; B60L 3/12; B62M 6/50

(52) U.S. Cl. CPC G01G 19/02; B60L 3/12; B62M 6/50; G01L 5/0042; G01B 21/22

(57) ABSTRACT

A method for ascertaining the total mass of an electrically drivable vehicle includes: ascertaining, for a purely electrically driven vehicle, a total mass of the vehicle on the basis of Newton's second law, taking into account a slope and a travel speed of the vehicle. As an alternative or in addition, a compression travel within a subassembly of the occupied vehicle is measured, and the total mass of the vehicle is inferred from a predefined or previously ascertained stiffness of the compression travel, taking into account a current weight distribution.

### BACKGROUND OF THE INVENTION

1. Field of the Invention

The present invention relates to methods and devices for ascertaining the total mass of an electrically drivable vehicle. More specifically, the present invention relates to methods and devices for ascertaining the total mass of an electrically drivable bicycle, whose drive is meant to provide a supplementary torque to the driver while taking the total mass into account.

Methods for generating a model, in which a torque can be monitored indirectly with the aid of a gradient, a speed, an engine torque and a driver speed, are known from the Japanese patent publication JP 11-334677 and from the German patent application publication DE 10 2010 017 742 A1. However, the use of the described models makes it necessary to determine a total mass of the vehicle to be driven, for which no efficient method is known.

International patent application publication WO 2008/095116 A2 describes an electrically drivable vehicle which, in order to increase the operating efficiency, is able to ascertain the speed, the increasability as well as the improvability of the maximum traveling speed on the basis of Newton's second law.

In contrast, German patent application publication DE 10 2012 200 179 A1 describes a control device for an electric vehicle, in which a seat switch is situated below a vehicle seat, which is actuated when a driver is seated and which outputs a seat signal in this case.

### BRIEF SUMMARY OF THE INVENTION

In the present invention, a first method is provided for determining a total mass of an electrically drivable vehicle, which includes the following steps: Ascertaining the speed and a slope on which the vehicle is traveling. In other words, a current speed of the vehicle and a slope along which the travel takes place at this particular speed are ascertained.

In addition, a drive torque is determined in a purely electrically driven vehicle. For instance, this may be accomplished by a measurement with the aid of a torque sensor in the region of the electrical drive train of an electrically drivable bicycle as the vehicle. In the present invention, the total mass of the vehicle is additionally ascertained based on Newton's second law, using the speed, the traveled slope and the drive torque of the electric motor.

The drive torque applied by the driver is ascertained with the aid of torque sensors, and/or a rotational pedal speed is ascertained with the aid of rpm sensors and taken into account when ascertaining the total mass. For example, torque sensors in the region of the pedals may be used in order to consider torques in the drive train of the vehicle generated by muscle force in the formula for Newton's second law. In the event that rpm sensors are mounted on the pedals of the vehicle, it can be monitored whether a user of the vehicle operates the pedals at a rotational speed that corresponds to the traveling speed. If the pedaling frequency is so high that an effect on the accelerative force of the vehicle is possible (the rotational speed thus corresponds to the wheel speed of the vehicle, taking a current transmission ratio into account), then an ascertainment of the total mass may be suspended until the rotational speed of the pedals drops below the aforementioned critical rotational speed or until the pedals are standing still. This makes it possible to consider interference variables introduced by the driver of the vehicle when ascertaining the total mass according to the present invention.

It is furthermore preferred that the vehicle's change in speed is determined and used when ascertaining the total mass. In other words, the mass of the driving vehicle (vehicle plus driver and possible payload mass) is ascertained, taking the vehicle's current change in speed into account. If a change in speed has been determined, a corresponding term “mass times acceleration” is able to be considered in the formula for Newton's second law. As a result, the total vehicle mass may be determined rapidly and precisely even if the speed varies.

According to another aspect of the present invention, a method for ascertaining the total mass of an electrically drivable vehicle is proposed, which includes the following steps: Ascertaining a compression of a first subassembly of the vehicle and ascertaining the total mass of the vehicle on the basis of the ascertained compression, taking into account a current distribution of weight forces that are acting on the vehicle through a driver. In the framework of the present invention, “compression” refers to a shortening of a clearance within a first subassembly as a result of an added load or an occupancy of the vehicle. The first subassembly may be achieved as a result of a component-inherent elasticity or a displaceability produced between two components of the subassembly that are mutually displaceable. Hooke's law may be utilized for this purpose, in that a portion of a weight force acting on the vehicle within the subassembly can be inferred via an assumed or known stiffness or elasticity within the first subassembly and via the compression. A current weight distribution on account of the additional loading and/or the vehicle occupancy is taken into account according to the present invention. For example, this may be ascertained based on the construction type of the vehicle in conjunction with a tilt sensor, or it may be assumed on the basis of values stored in a memory component. As an alternative or in addition, it is also possible to consider compressions of a second subassembly of the occupied vehicle in order to infer a current weight distribution. This offers the advantage that an exact weight force which is appropriate for the operating state can be ascertained for the total mass determination at low material expense or completely without additional material expense.

In a furthermore preferred manner, the compression within the first subassembly and/or within the second subassembly can be determined in conjunction with a first and a second component inside the vehicle, which are disposed so as to be mutually displaceable. This system can be situated in the undercarriage of the vehicle. A displacement of the first and the second component is provided as a function of an operation and/or a payload (an occupancy meaning a “payload” in this case). For example, a spring system in the undercarriage may be utilized as elasticity, via which the compression can be utilized for calculating an acting weight force and, subsequently, for calculating a total mass. This offers the advantage that, depending on the payload, considerable displacements occur between the different components of the system, which are able to be acquired in an exact manner with the aid of displacement sensors.

For instance, the compression is preferably ascertainable by a first magnetic field sensor on the first component, whose measuring signal is affected by a magnetic field generated on the second component. To do so, for example, the second component may include a permanent magnet, whose magnetic field is recorded by the magnetic field sensor to a variable extent as a function of the compression. This ensures a contactless ascertainment of the compression that is impervious to soiling.

In a furthermore preferred manner, the first component may be situated on a seat for the driver and/or on a steering device and/or a wheel suspension. This is advantageous inasmuch as a springy seat or a springy body component exhibits a spring travel as a function of the occupancy and/or loading, which is able to be resolved very well by many suitable displacement sensors.

Moreover, it is preferred that the second component is a component which is encompassed by a wheel of the vehicle, and that the first component is fixedly mounted on the vehicle in relation to the wheel. In a spring-mounted suspension of the wheel, significant compression of the spring travel as a function of the payload or the occupancy of the vehicle must be assumed.

According to a further aspect of the present invention, an electrically drivable vehicle is proposed, which encompasses an electric drive, e.g., an electric motor, a device for ascertaining the speed of the vehicle, such as an engine-speed sensor or a satellite-based locating system, and a device for ascertaining the drive torque applied by the driver. The latter device, for instance, may include a force sensor in the pedal assembly of the vehicle. The electrically drivable vehicle furthermore includes a device for ascertaining a slope along which the vehicle is traveling, which may include an acceleration sensor operated as a tilt sensor, for instance. In addition, a device for ascertaining a drive torque generated by the electric drive is provided. The torque may be ascertained directly (for instance with the aid of a force sensor) or indirectly (for instance with the aid of a power-consumption of the electric drive). Moreover, the electrically drivable vehicle includes an evaluation unit and a device for ascertaining the acceleration of the vehicle. The acceleration of the vehicle may be determined via wheel sensors or in a satellite-based manner, for instance. According to the present invention, the evaluation unit is set up to evaluate signals from the aforementioned devices and to execute a method as described herein. This makes it possible to ascertain a total mass of the vehicle and to utilize it when determining the operating point of the vehicle. For example, a slope is able to be measured and used for ascertaining a downhill-slope force of the vehicle while utilizing the ascertained total mass of the vehicle. In this way the electric drive is actuable in conformance with corresponding specifications.

The electrically drivable vehicle proposed by the present invention preferably may also include an input device, which is set up to induce the evaluation unit to execute a method as described previously in detail, in response to a user input. The input device, for instance, may include a keyboard and/or a touch-sensitive surface, and/or speech recognition and/or a device for receiving electronically generated signals. In this way either a direct input by the user of the vehicle or a linkage of electronic mobile devices carried by the user may take place. These may include corresponding sets of instructions, which induce the electronic mobile devices to output control signals for generating an input into the evaluation unit. As a result, the aforementioned method is able to be executed only in response to a user wish or user input, so that an unnecessary new ascertainment of the total vehicle mass by algorithms for ascertaining the operating state is avoided.

### BRIEF DESCRIPTION OF THE DRAWINGS

FIG. 1 shows a block diagram of an exemplary embodiment for an electrically drivable vehicle according to the present invention.

FIG. 2 shows a schematic overview of components of an exemplary embodiment for a system according to the present invention.

FIG. 3 shows a flow chart which illustrates steps of a method according to one exemplary embodiment of the present invention.

### DETAILED DESCRIPTION OF THE INVENTION

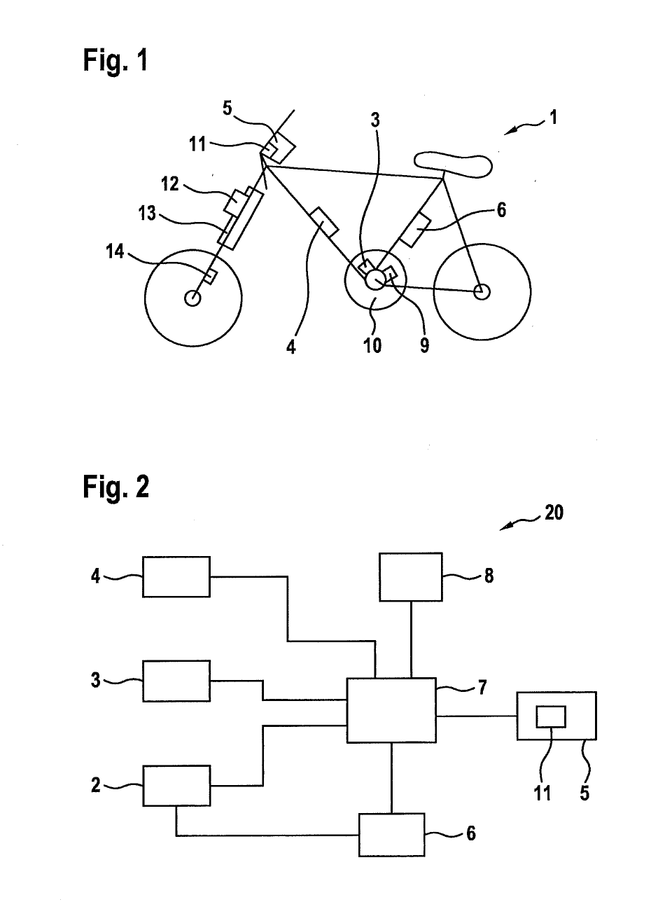

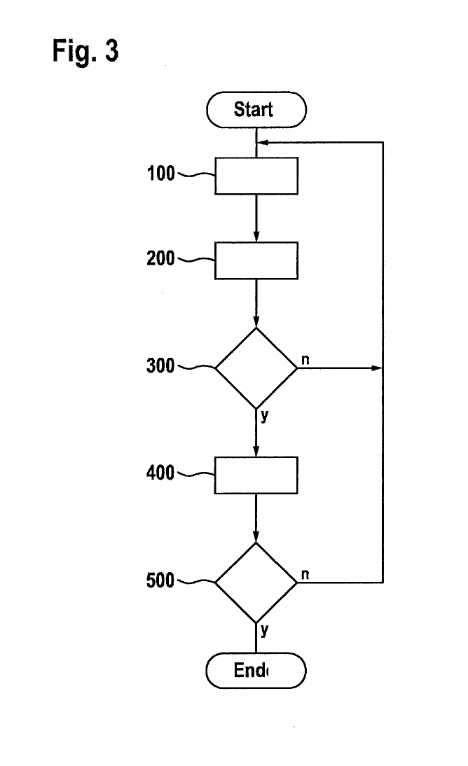

FIG. 1 shows a bicycle 1 as an electrically drivable vehicle. Bicycle 1 is equipped with a battery pack 6 and a motor 10 for the drive. In addition, a torque sensor 3 for ascertaining a torque applied by the driver of bicycle 1 is situated in the region of the bottom bracket bearing. A torque sensor 9 for determining a torque introduced by motor 10 is provided as well. An acceleration sensor 4 is situated on the frame of bicycle 1 in order to sense a tilt angle of bicycle 1 vis-à-vis the gravitational acceleration. Disposed as evaluation unit in the region of the handlebars of bicycle 1 is an onboard computer 5, which includes a processor 11. The processor has program code (not shown), which includes instructions required for implementing a method according to the present invention (in connection with FIG. 3). Moreover, bicycle 1 has a suspension fork 13, whose frame-side component includes a Hall-effect sensor 12 as magnetic field sensor. The part of suspension fork 13 provided on the wheel has a magnetic element 14, which is displaceable in relation to Hall-effect sensor 12 via suspension fork 13. In this way it is possible to detect a compression of suspension fork 13 due to a payload or occupancy of bicycle 1, with the aid of magnetic element 14 and Hall-effect sensor 12.

FIG. 2 shows a schematic overview of components of a system 20 for executing a method according to the present invention. An engine control 7 as evaluation unit is connected to an acceleration sensor 4 as tilt sensor, to a memory 8, to a torque sensor 3 for ascertaining the torque introduced via the pedals, to an electric motor 2, to a battery pack 6 for supplying motor 2 with electrical energy, and to an on-board computer 5, which includes a processor 11. It is possible to operate either motor control 7 or on-board computer 5 (man/machine interface (MMI)) or its processor 11 as evaluation unit within the meaning of the present invention. The method of functioning of the illustrated components comes about as described earlier in connection with the introduction of the aspects of the present invention.

FIG. 3 shows a flow chart, which visualizes method steps of a method according to an exemplary embodiment of the present invention. The method begins (“start”) by a user input via onboard computer 5. In step 100, a speed and an uphill slope traveled by vehicle 1 are ascertained. The speed in particular is determined while traveling the uphill slope. In step 200, the torque introduced by electric motor 10 is ascertained while no torque is introduced by the driver via the pedals of vehicle 1. In the event that it is determined in step 300 that the drive torque is not equal to 0 Nm (N), the method continues with ascertaining the speed and gradient in step 100. As soon as driver torque is 0 Nm (Y), the total mass of vehicle 1 is determined in step 400 according to Newton's second law on the basis of the ascertained quantities. In step 500, it is determined whether a predefined terminating condition is satisfied. The predefined terminating condition may be a user interaction, for instance, or an execution of the method may be terminated on the basis of an ascertained travel speed of 0 km/h, for example. If the predefined terminating condition has not been satisfied (N), the method continues with an ascertainment of the speed and the gradient in step 100. If the predefined terminating condition has been satisfied (Y), the method ends (“end”).

According to the present invention, an ascertaining of weight forces acting on the vehicle by a driver and/or a payload via a compression of a component or a subassembly of the vehicle is proposed, and a multitude of compression paths are identified on the vehicle, without thereby restricting the scope of the present invention. For example, it is possible to provide a magnetic field sensor on the handlebars, preferably in a housing of on-board computer 5. For instance, a permanent magnet disposed in the wheel in order for ascertaining the wheel speed may be used as magnetic element. In the present invention, a measurement of the speed or the change in speed may be determined according to known methods (e.g., via a reed contact), and the slope along which the vehicle is traveling is likewise able to be ascertained with the aid of known methods (e.g., via acceleration or pressure sensors). The same applies to the motor torque, which is usually input either by the driver or by an associated characteristics map. The driver torque can either be ascertained via known torque sensor systems, e.g., in the pedal assembly of the vehicle, or an influence on the part of the driver can be excluded for the reason that a torque sensor in the pedal assembly makes it appear unlikely that the pedals are actuated by a user of the vehicle. In the ascertaining of the total mass according to the present invention based on Newton's second law (movement equation), a rolling resistance and/or an aerodynamic drag as a function of the determined travel speed are/is preferably assumed as fixed value(s), derived from characteristics maps, or completely disregarded. If a change in speed of the vehicle and also an introduction of a torque by the driver do not take place, the downgrade force results directly from the motor torque and the variables assumed for the rolling friction force and the aerodynamic drag. A speed signal and/or a change-in-speed signal in conjunction with an assumed or ascertained total mass may naturally be taken into account via a term for the mass.

A determined compression can be converted into a total payload mass as a function of the bicycle type and an associated known weight force distribution. For example, it may be ascertained via experiments that the mass of the driver is acting on the handlebars to approximately 30% and on the saddle of a bicycle to approximately 70%. If a compression of a suspension fork (below the handlebars) in conjunction with the stiffness of the suspension fork is determined as a weight force of approximately 300 N is determined in the present invention, then the fact that 70% of the payload mass is introduced into the vehicle via the saddle is able to be taken into account in a calculation model. In other words, based on the known percentage weight force distribution, it can be calculated that the payload mass (payload including the driver) amounts to 1000 N.

For example, the compression may be inferred from a change in the peak value of the magnetic field, measured across a predefined time period, as a function of the payload, and an acting weight force can be assigned as a function of a characteristics map stored in a memory element. It is of no consequence here whether the element which generates the magnetic field, and the element which ascertains the magnetic field are disposed essentially equidistantly from each other during the operation or whether they assume a predefined distance from each other only on a recurring basis. In other words, a front wheel hub motor may include a magnetic field sensor in the drive unit, and a magnet used for ascertaining the compression of the suspension fork may be disposed above the spring (the “compression travel”) on a component of the handle bars of the vehicle. The same applies to a vehicle driven by a rear wheel hub motor and a permanent magnet situated on the frame.

It is of course possible to ascertain the characteristics maps or the associated payload masses either by way of calculation and to store them in the system in the form of equations, but as an alternative or in addition, a calibration using predefined test masses in a multitude of predefined operating states may be implemented as well. This calibration may then be utilized in the course of driving and depending on the compression, an interpolation between the calibration points may take place. The described methods and the device are naturally combinable with each other. Suitable weighting of the results is preferably provided in order to increase the influence of especially suitable methods or compression travels as a function of an operating state, for example, and to thereby obtain an especially precise and reliable result.

A core idea of the present invention consists of improving the monitoring of operating states of an electrically drivable vehicle by methods for ascertaining the total mass of the vehicle. According to one aspect, in a purely electrically driven vehicle, a total mass of the vehicle is ascertained on the basis of Newton's second law, taking a slope and a travel velocity of the vehicle into account.

As an alternative or in addition, a compression travel within a subassembly of the occupied vehicle is able to be measured, for instance with the aid of a magnetic element and a magnetic field sensor, and the total mass of the vehicle can be inferred from a predefined or previously ascertained stiffness of the compression travel, via Hooke's law, taking a current weight distribution into consideration.

Although the aspects according to the present invention have been described in detail on the basis of the appended drawing figures in the form of exemplary embodiments, the modifications, combinations and omissions of the disclosed features remain within the expert capabilities of one skilled in the art, without departing from the scope of the present invention, the protection scope of which is defined by the appended claims.

1-10. (canceled)

11. A method for ascertaining a total mass of an electrically drivable vehicle, the method comprising:
ascertaining a speed of the vehicle and a slope of a surface on which the vehicle is located;
ascertaining a drive torque generated by an electric drive of the vehicle;
ascertaining, with the aid of at least one of a torque sensor and an rpm sensor, a drive torque applied by a driver of the vehicle; and
ascertaining the total mass of the vehicle on the basis of Newton's second law.

12. The method as recited in claim 11, further comprising:
ascertaining a change in the speed of the vehicle, wherein the ascertained change in the speed is used in ascertaining the total mass.

13. A method for ascertaining a total mass of an electrically drivable vehicle, the method comprising:
ascertaining a compression of a first subassembly of the vehicle, wherein the vehicle is occupied by at least the driver; and
ascertaining the total mass of the vehicle on the basis of the ascertained compression, taking into account a current distribution of weight forces acting on the vehicle.

14. The method as recited in claim 13, wherein the first subassembly is a subassembly in a body component of the vehicle, the first subassembly including a first component and a second component which are mutually displaceable.

15. The method as recited in claim 14, wherein the compression of the first subassembly is determined with the aid of a magnetic field sensor on the first component, and wherein a measuring signal of the magnetic field sensor is influenced by a magnetic field generated on the second component.

16. The method as recited in claim 15, wherein the first component is at least one of (i) a component of a seat for the driver, (ii) a component of a steering device, and (iii) a component of a wheel suspension.

17. The method as recited in claim 15, wherein the second component is a wheel of the vehicle and the first component is a component of the vehicle which is stationary with respect to the wheel.

18. An electrically drivable vehicle, comprising:
an electrical drive;
a first device for ascertaining a speed of the vehicle;
a second device for ascertaining a drive torque applied by a driver of the vehicle;
a third device for ascertaining a slope of a surface on which the vehicle is traveling;
a fourth device for ascertaining a drive torque applied by the electric drive; and
an evaluation unit configured to evaluate signals from the first through fourth devices and to ascertain the total mass of the vehicle on the basis of Newton's second law.

19. The electrically drivable vehicle as recited in claim 18, further comprising:
an input device configured to trigger the evaluation unit to evaluate signals from the first through fourth devices and to ascertain the total mass of the vehicle in response to a driver input.
